(19) United States
(12) Patent Application Publication
(10) Pub. No.: US 2024/0304889 A1
(43) Pub. Date: Sep. 12, 2024

(54) THERMAL MANAGEMENT SYSTEM

(71) Applicant: TOYOTA JIDOSHA KABUSHIKI KAISHA, Toyota-shi (JP)

(72) Inventor: Tomoaki SUZUKI, Nagoya-shi (JP)

(73) Assignee: TOYOTA JIDOSHA KABUSHIKI KAISHA, Toyota-shi (JP)

(21) Appl. No.: 18/543,243

(22) Filed: Dec. 18, 2023

(30) Foreign Application Priority Data
Mar. 9, 2023 (JP) 2023-036660

(51) Int. Cl. H01M 10/633; B60L 58/26; B60L 58/27; H01M 10/613; H01M 10/615; H01M 10/625; H01M 10/6568

(52) U.S. Cl. CPC H01M 10/633; B60L 58/26; B60L 58/27; H01M 10/613; H01M 10/615; H01M 10/625; H01M 10/6568; B60H 1/00278; B60H 2001/00307; H01M 2220/20

(57) ABSTRACT

The thermal management system includes a power storage device that exchanges heat with the heat medium flowing through a first flow path, a drive device that exchanges heat with the heat medium flowing through a second flow path, and a radiator provided in a third flow path, a chiller provided in the fourth flow path, and a switching device. The switching device is configured to separate the second flow path from the other flow paths when the temperature difference between the high temperature part and the low temperature part of the power storage device is equal to or higher than a threshold value, and makes a circuit in which the heat transfer medium flows through at least the first flow path and the fourth flow path.

### CROSS-REFERENCE TO RELATED APPLICATION

This application claims priority to Japanese Patent Application No. 2023-036660 filed on Mar. 9, 2023 incorporated herein by reference in its entirety.

### BACKGROUND

### 1. Technical Field

The present disclosure relates to a thermal management system.

### 2. Description of Related Art

Japanese Unexamined Patent Application Publication No. 2020-17358 (JP 2020-17358 A) discloses a battery temperature control system that includes an on-vehicle battery and a cooling device. In this battery temperature control system, a plurality of cells included in the on-vehicle battery is controlled such that the temperatures of the cells are equalized.

### SUMMARY

In an electrical device such as an electrified vehicle, in addition to equalizing temperatures of a power storage device, it may be important to effectively utilize heat generated by a drive device including an inverter and a motor.

An object of the present disclosure is to provide a thermal management system that can both equalize the temperatures of the power storage device and effectively utilize heat generated by the drive device.

A thermal management system according to one aspect of the present disclosure is provided in an electrical device, and includes:
a first flow path, a second flow path, a third flow path, and a fourth flow path through which a heat medium is able to flow;
a power storage device that exchanges heat with the heat medium flowing through the first flow path;
a drive device that exchanges heat with the heat medium flowing through the second flow path and supplies driving force to the electrical device;
a radiator provided in the third flow path;
a chiller provided in the fourth flow path; and
a switching device that is able to switch a connection state of the first flow path, the second flow path, the third flow path, and the fourth flow path, in which
when a temperature difference between a high temperature portion and a low temperature portion of the power storage device is equal to or greater than a threshold value, the switching device separates the second flow path from other flow paths, and makes a circuit in which the heat medium circulates through at least the first flow path and the fourth flow path.

According to the present disclosure, it is possible to provide a heat management system that can both equalize the temperatures of the power storage device and effectively utilize heat generated by the drive device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a thermal management system in an embodiment of the present disclosure;

FIG. 2 is a diagram showing the configuration of a thermal management circuit in the thermal management system;

FIG. 3 is a diagram schematically illustrating the temperature leveling mode of the thermal management circuit; and

FIG. 4 is a flowchart showing control details of the thermal management system.

### DETAILED DESCRIPTION OF EMBODIMENTS

Embodiments of the present disclosure will be described in detail below with reference to the drawings. In the drawings, the same or corresponding parts are given the same reference numerals, and the description thereof will not be repeated.

In the following, a configuration in which the thermal management system 1 according to the present disclosure is installed in an electrified vehicle (not shown) will be described as an example. The electrified vehicle is preferably a vehicle equipped with a battery 173 for driving, such as a battery electric vehicle (BEV). The electrified vehicle may be a hybrid electric vehicle (HEV), a plug-in hybrid electric vehicle (PHEV), or a fuel cell electric vehicle (FCEV). However, the application of the thermal management system according to the present disclosure is not limited to vehicles. Note that the electrified vehicle is an example of an “electrical device” in the present disclosure.

### Overall Structure

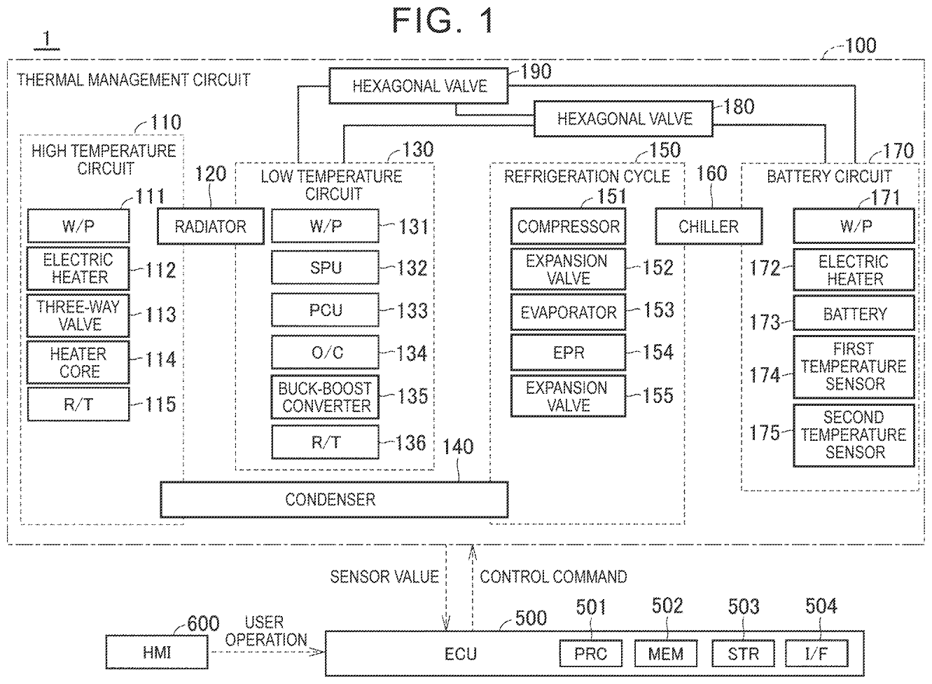

FIG. 1 is a diagram showing the configuration of a thermal management system in an embodiment of the present disclosure. The thermal management system 1 includes a thermal management circuit 100, an electronic control unit (ECU) 500, and a human machine interface (HMI) 600. Note that ECU 500 is an example of a “control device” of the present disclosure.

The thermal management circuit 100 is configured so that a medium (such as water) that transfers heat flows therethrough. As shown in FIG. 1, the thermal management circuit 100 includes, for example, a high temperature circuit 110, a radiator 120, a low temperature circuit 130, a condenser 140, a refrigeration cycle 150, a chiller 160, a battery circuit 170, and a hexagonal valve 180 and a hexagonal valve 190. Note that each of the hexagonal valve 180 and the hexagonal valve 190 is an example of a “switching device” of the present disclosure.

The high temperature circuit 110 includes, for example, a water pump (W/P) 111, an electric heater 112, a three-way valve 113, a heater core 114, a reservoir tank (R/T) 115, and a heat medium (not shown) (such as water).

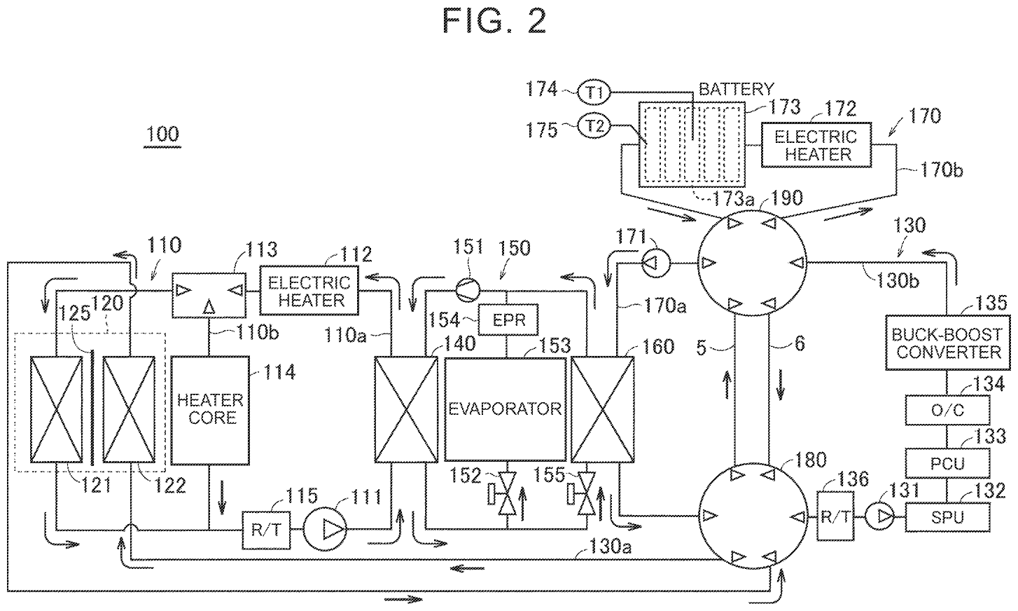

Radiator 120 is connected to (ie, shared with) both high temperature circuit 110 and low temperature circuit 130. Radiator 120 includes a high temperature (HT) radiator 121 (FIG. 2) and a low temperature (LT) radiator 122 (FIG. 2). Note that the low-temperature radiator 122 is an example of a “radiator” in the present disclosure.

The low temperature circuit 130 includes, for example, a water pump 131, a Smart Power Unit (SPU) 132, a Power Control Unit (PCU) 133, an oil cooler (O/C) 134, a buck-boost converter 135, and a reservoir tank 136., and a heat medium (such as water) not shown. Note that the PCU 133 and the oil cooler 134 are an example of a “drive device” in the present disclosure.

The condenser 140 is connected to both high temperature circuit 110 and refrigeration cycle 150.

The refrigeration cycle 150 includes, for example, a compressor 151, an expansion valve 152, an evaporator 153, an Evaporative Pressure Regulator (EPR) 154, an expansion valve 155, and a working medium (not shown) (such as water or a medium with a lower boiling point than water).

Chiller 160 is connected to both refrigeration cycle 150 and battery circuit 170.

The battery circuit 170 includes, for example, a water pump 171, an electric heater 172, a battery 173, a first temperature sensor 174, and a second temperature sensor 175. Note that the water pump 171 and the battery 173 are examples of a “pump” and a “power storage device” of the present disclosure, respectively.

Each of hexagonal valve 180 and hexagonal valve 190 is connected to low temperature circuit 130 and battery circuit 170. The configuration of the thermal management circuit 100 will be explained in detail with reference to FIG. 2.

ECU 500 controls thermal management circuit 100. ECU 500 includes a processor 501, memory 502, storage 503, and interface 504.

Processor 501 is, for example, a Central Processing Unit (CPU) or a Micro-Processing Unit (MPU). Memory 502 is, for example, Random Access Memory (RAM). The storage 503 is a rewritable nonvolatile memory such as a hard disk drive (HDD), solid state drive (SSD), or flash memory. Storage 503 stores a system program including an operating system (OS) and a control program including computer-readable codes necessary for control calculations. The processor 501 reads system programs and control programs, expands them into the memory 502, and executes them, thereby realizing various processes. Interface 504 controls communication between ECU 500 and components of thermal management circuit 100.

ECU 500 generates control commands based on sensor values obtained from various sensors (for example, first temperature sensor 174 and second temperature sensor 175) included in thermal management circuit 100, user operations accepted by HMI 600, etc. The generated control command is output to the thermal management circuit 100. ECU 500 may be divided into multiple ECUs for each function. Further, although FIG. 1 shows an example in which the ECU 500 includes one processor 501, the ECU 500 may include a plurality of processors. The same applies to the memory 502 and storage 503.

In this specification, a “processor” is not limited to a narrowly defined processor that executes processing using a stored program method, but may include hard-wired circuits such as an Application Specific Integrated Circuit (ASIC) and a Field-Programmable Gate Array (FPGA). Therefore, the term “processor” can also be read as a processing circuitry in which processing is predefined by computer readable code and/or hardwired circuitry.

The HMI 600 is a display with a touch panel, an operation panel, a console, etc. HMI 600 accepts user operations for controlling thermal management system 1. HMI 600 outputs a signal indicating a user operation to ECU 500.

### Thermal Management Circuit Configuration

FIG. 2 is a diagram showing an example of the configuration of the thermal management circuit 100 in this embodiment. As shown in FIG. 2, the high temperature circuit 110 has a flow path 110a and a flow path 110b. The flow path 110a connects the water pump 111, the condenser 140, the electric heater 112, the three-way valve 113, the high temperature radiator 121, the reservoir tank 115, and the water pump 111 in this order.

The flow path 110b connects the three-way valve 113, the heater core 114, and the reservoir tank 115 in this order.

The heat medium (for example, water) in the high-temperature circuit 110 flows through at least one of a first path that circulates in this order: water pump 111-condenser 140-electric heater 112-three-way valve 113-heater core 114-reservoir tank 115-water pump 111, and the second paths that circulates in this order: water pump 111-condenser 140-electric heater 112-three-way valve 113-high temperature radiator 121-reservoir tank 115-water pump 111. The three-way valve 113 switches the flow path of the heat medium so that the heat medium flows through at least one of the first path and the second path.

Water pump 111 circulates a heat medium within high temperature circuit 110 according to control commands from ECU 500. The condenser 140 exchanges heat between the heat medium and the working medium in refrigeration cycle 150. Electric heater 112 heats the heat medium. The heater core 114 heats air supplied to a vehicle cabin (not shown) of the electrified vehicle using a heat medium. The reservoir tank 115 maintains the pressure and amount of the heat medium in the high temperature circuit 110 by storing a portion of the heat medium in the high temperature circuit 110.

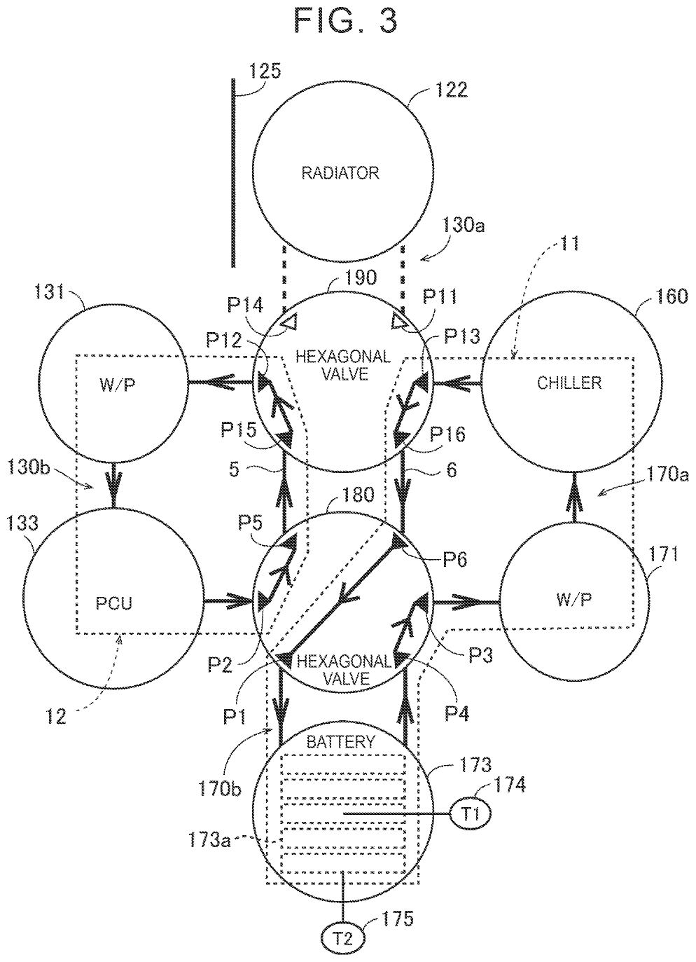

As shown in FIGS. 2 and 3, the low temperature circuit 130 includes a flow path 130a and a flow path 130b. The flow path 130a connects the hexagonal valve 180, the low-temperature radiator 122, and the hexagonal valve 180 in this order. The flow path 130b connects the hexagonal valve 190, the hexagonal valve 180, the reservoir tank 136, the water pump 131, the SPU 132, the PCU 133, the oil cooler 134, the buck-boost converter 135, and the hexagonal valve 190 in this order. The flow path 130b is in thermal contact with the SPU 132, the PCU 133, the oil cooler 134, and the buck-boost converter 135. Note that the flow path 130a is an example of the “third flow path” of the present disclosure, and the flow path 130b is an example of the “second flow path” of the present disclosure.

The heat medium (for example, water) in the low temperature circuit 130 includes, for example, a water pump 131-SPU 132-PCU 133-oil cooler 134-buck-boost converter 135-hexagonal valve 190-hexagonal valve 180-low-temperature radiator 122-hexagonal valve 180-reservoir. The water flows through a path that circulates through tank 136 and water pump 131 in this order.

Water pump 131 circulates a heat medium within low temperature circuit 130 according to control instructions from ECU 500. SPU 132 controls charging and discharging of battery 173 according to control commands from ECU 500. PCU 133 converts DC power supplied from battery 173 into AC power according to control commands from ECU 500, and supplies the AC power to a motor (not shown) built into the transaxle. The oil cooler 134 circulates lubricating oil for the motor using an Electrical Oil

Pump (EOP) (not shown). The oil cooler 134 cools the transaxle by heat exchange between the heat medium circulating in the low temperature circuit 130 and the lubricating oil of the motor. The SPU 132, PCU 133, oil cooler 134, and buck-boost converter 135 are cooled by the heat medium circulating in the low-temperature circuit 130. The reservoir tank 136 maintains the pressure and amount of the heat medium in the low temperature circuit 130 by storing a portion of the heat medium in the low temperature circuit 130. Each of hexagonal valve 180 and hexagonal valve 190 switches the path of the heat medium in low temperature circuit 130 and battery circuit 170 in accordance with a control command from ECU 500. The hexagonal valve 180 includes six ports P1 to P6, and the hexagonal valve 190 includes six ports P11 to P16. The hexagonal valve 180 is connected to a hexagonal valve 190. Specifically, port P5 of the hexagonal valve 180 and port P15 of the hexagonal valve 190 are connected by the connection flow path 5, and port P6 of the hexagonal valve 180 and port P16 of the hexagonal valve 190 are connected by the connection flow path 6. Note that the connection flow path 5 and the connection flow path 6 together with the hexagonal valves 180 and 190 constitute the “switching device” of the present disclosure. The low temperature radiator 122 is placed near the high temperature radiator 121. The heat medium flowing in the low temperature radiator 122 exchanges heat with the heat medium flowing in the high temperature radiator 121. The thermal management system 1 includes a grille shutter 125 located near a low temperature radiator 122. The grille shutter 125 can adjust the amount of air flowing toward the low-temperature radiator 122 by adjusting its opening according to a control command from the ECU 500. Note that the above transaxle may be provided in the low temperature circuit 130 instead of the oil cooler 134.

The working medium in the refrigeration cycle 150 flows through at least one of a first path that circulates in this order: compressor 151-condenser 140-expansion valve 152-evaporator 153-EPR 154-compressor 151, and a second path that circulates in this order: compressor 151-condenser 140-expansion valve 155-chiller 160-compressor 151. The expansion valve 152 and the expansion valve 155 switch the flow path of the working medium so that the working medium flows through at least one of the first path and the second path.

The compressor 151 compresses the gas phase working medium flowing out from the chiller 160. The condenser 140 condenses the working medium by exchanging heat between the gaseous working medium discharged from the compressor 151 and the heat medium flowing through the high temperature circuit 110. Expansion valve 152 and expansion valve 155 expand the working medium flowing out from condenser 140. The evaporator 153 evaporates the working medium by exchanging heat between the working medium flowing out from the expansion valve 152 and the air supplied to the vehicle cabin of the electrified vehicle. The evaporation pressure regulating valve 154 regulates the pressure of the working medium flowing out from the evaporator 153.

As shown in FIGS. 2 and 3, the battery circuit 170 includes a flow path 170a connecting a hexagonal valve 190, a water pump 171, a chiller 160, and a hexagonal valve 180 in this order, a hexagonal valve 190, an electric heater 172, and a battery 173. and a flow path 170b connecting the hexagonal valve 190 in this order. The flow path 170b is in thermal contact with the surface of the battery 173. Note that the flow path 170a is an example of the “fourth flow path” of the present disclosure, and the flow path 170b is an example of the “first flow path” of the present disclosure.

The heat medium in the battery circuit 170 (the same heat medium as the heat medium flowing through the low temperature circuit 130) is, for example, water pump 171-chiller 160-hexagonal valve 180-hexagonal valve 190-electric heater 172-battery 173-hexagonal valve 190-water. It flows through the path that circulates through the pump 171 in this order.

Water pump 171 circulates a heat medium within battery circuit 170 according to control commands from ECU 500. Chiller 160 cools the heat medium circulating in battery circuit 170 by exchanging heat between the working medium circulating in refrigeration cycle 150 and the heat medium circulating in battery circuit 170. Electric heater 172 heats the heat medium according to control instructions from ECU 500. The battery 173 supplies power for running to a motor built into the transaxle. Battery 173 may be heated using electric heater 172 or cooled using chiller 160. The battery 173 includes a plurality of cells 173a (FIGS. 2 and 3) arranged in one direction. Note that the central portion of the battery 173 (cell 173a disposed in the center) is adjacent to other cells and has difficulty in escaping heat, so it tends to reach a relatively high temperature. The periphery of the battery 173 (the cells 173a arranged around the periphery) is closer to the outside air than the center and can easily radiate heat, so the temperature tends to be relatively low. The first temperature sensor 174 detects the temperature of the high temperature portion (center portion) of the battery 173. The second temperature sensor 175 detects the temperature of the low temperature section (peripheral section) of the battery 173. mode

FIG. 3 is a conceptual diagram showing an overview of a predetermined mode (hereinafter sometimes referred to as temperature leveling mode) in the thermal management circuit 100, which is formed by controlling the hexagonal valve 180 and the hexagonal valve 190. By controlling the hexagonal valve 180 and the hexagonal valve 190, the connection state of each flow path 130a, 130b, 170a, 170b and each connection flow path 5, 6 is switched. Thereby, the thermal management circuit 100 is switched to a plurality of modes including the temperature leveling mode.

Here, in the battery 173, when the temperature of some of the cells 173a reaches a preset upper limit or lower limit during charging and discharging of each cell 173a, the temperature of the other cells 173a reaches the upper limit or lower limit. Even if the limit has not been reached, charging and discharging of the battery 173 may be restricted.

Therefore, in the present embodiment, the ECU 500 controls the hexagonal valve 180 and the hexagonal valve 190 to enter the temperature leveling mode shown in FIG. 3, when the temperature difference between the high temperature portion and the low temperature portion of the battery 173 (the difference between the detection value T1 of the first temperature sensor 174 and the detection value T2 of the second temperature sensor 175) is equal to or greater than a threshold value Ta. Specifically, in the temperature leveling mode, the hexagonal valve 180 connects a path that communicates ports P1 and P6, a path that communicates ports P2 and P5, and a path that communicates ports P3 and P4., and the hexagonal valve 190 forms a path that communicates ports P12 and P15 and a path that communicates ports P13 and P16.

As a result, the first closed circuit 11 in which the heat medium circulates through the flow path 170b corresponding to the “first flow path” and the flow path 170a corresponding to the “fourth flow path”, and the second closed circuit 12 in which the heat medium circulates through the flow path 13b corresponding to the “second flow path” are formed, and a flow path 130a corresponding to a “third flow path” is separated. At this time, in order to prevent heat exchange in the chiller 160, the compressor 151 is stopped or the expansion valve 155 is closed.

In other words, in the temperature leveling mode shown in FIG. 3, the heat medium flowing through the first closed circuit 11 circulates through the first closed circuit 11 without exchanging heat with other devices, and the heat generated in the PCU 133 and the transaxle (not shown) is stored in the heat medium flowing through the second closed circuit 12. In the first closed circuit 11, the heat medium transfers heat from the high temperature section of the battery 173 to the low temperature section of the battery 173 via the chiller 160.

As a result, it is possible to both equalize the temperature of the battery 173 and effectively utilize the heat generated from the drive device such as the PCU 133.

Furthermore, in the temperature equalization mode, the ECU 500 stops the water pump 171 in the first closed circuit 11 when the temperature difference (T1−T2) of the battery 173 becomes less than the set value Tb, which is smaller than the threshold value Ta. Note that in the temperature equalization mode, the ECU 500 may stop the water pump 171 in the first closed circuit 11 when the temperature difference becomes less than the threshold value Ta.

### Control Method of Thermal Management Circuit

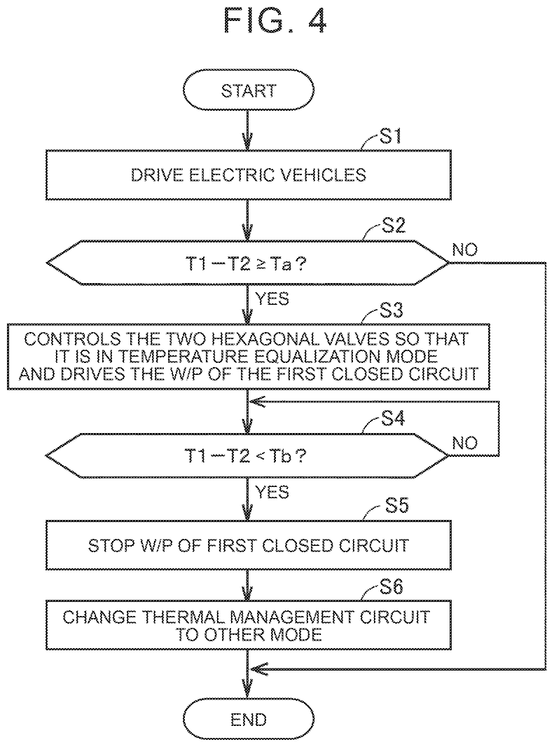

Next, a method for controlling the thermal management system 1 will be explained with reference to the flowchart shown in FIG. 4. Note that the flow shown in FIG. 4 is just an example, and the control content in the present disclosure is not limited to the example shown in FIG. 4.

First, the ECU 500 drives the electrified vehicle (starts up the driving system) (S1). Specifically, when a start button (not shown) of the electrified vehicle is pressed, the PCU 133 and the battery 173 are electrically connected (by the SMR (not shown)). ECU 500 detects that the electrified vehicle is driven by receiving a predetermined internal signal in the electrified vehicle.

Next, the ECU 500 determines whether the temperature difference (T1−T2) between the high temperature portion and the low temperature portion of the battery 173 is equal to or greater than a threshold value Ta [° C.] (S2). The threshold value Ta may be set to 10° C., for example.

If the temperature difference (T1−T2) is less than the threshold value Ta (No in S2), the ECU 500 ends the control. On the other hand, if the temperature difference (T1−T2) is greater than or equal to the threshold value Ta (Yes in S2), the ECU 500 controls the hexagonal valve 180 and the hexagonal valve 190 so that the thermal management circuit 100 enters the temperature equalization mode shown in FIG. 3, and drives the water pump 171 of the first closed circuit 11 (S3).

Subsequently, the ECU 500 determines whether the temperature difference (T1−T2) is less than the set value Tb (S4). As a result, if the temperature difference (T1−T2) is greater than or equal to the set value Tb (No in S4), the ECU 500 returns to S4 again. The set value Tb may be set to 5° C., for example.

On the other hand, if the temperature difference (T1−T2) is less than the set value Tb (Yes in S4), the ECU 500 stops the water pump 171 of the first closed circuit 11 (S5). This reduces the power required to drive the water pump 171.

After that, the ECU 500 controls each of the hexagonal valves 180 and 190 so that the thermal management circuit 100 enters a mode different from the temperature leveling mode (S6).

As described above, in the thermal management system 1 according to the first embodiment, when the temperature difference between the high temperature part (for example, the center part) and the low temperature part (for example, the peripheral part) of the battery 173 exceeds the threshold value Ta, the first closed circuit 11 and a second closed circuit 12 are formed. Therefore, the heat medium transfers heat from the high temperature section of the battery 173 to the low temperature section of the battery 173 via the chiller 160. Further, in the temperature leveling mode, the flow path 130b (second flow path) is separated. Therefore, the heat generated by the drive device is effectively accumulated in the heat medium flowing through the flow path 130b. Therefore, it is possible to both equalize the temperature of the battery 173 and effectively utilize the heat generated from the drive device.

In the above embodiment, in the temperature leveling mode, a circuit in which the heat medium circulates through the flow path 170b, the flow path 130a, and the flow path 170a is formed as the first closed circuit 11, and even when the grille shutter 125 is closed, good.

It will be appreciated by those skilled in the art that the exemplary embodiments described above are specific examples of the following aspects.

### Aspect 1

A thermal management system provided in an electrical device, the thermal management system comprising:
a first flow path, a second flow path, a third flow path, and a fourth flow path through which a heat medium is able to flow;
a power storage device that exchanges heat with the heat medium flowing through the first flow path;
a drive device that exchanges heat with the heat medium flowing through the second flow path and supplies driving force to the electrical device;
a radiator provided in the third flow path;
a chiller provided in the fourth flow path; and
a switching device that is able to switch a connection state of the first flow path, the second flow path, the third flow path, and the fourth flow path, wherein
when a temperature difference between a high temperature portion and a low temperature portion of the power storage device is equal to or greater than a threshold value, the switching device separates the second flow path from other flow paths, and makes a circuit in which the heat medium circulates through at least the first flow path and the fourth flow path.

In this thermal management system, when the temperature difference between the high temperature part (for example, the center) and the low temperature part (for example, the peripheral part) of the power storage device exceeds a threshold value, the heat medium is transferred from the high temperature part of the power storage device to the power storage device via the chiller. Transfers heat to low temperature areas. Further, when the temperature difference is equal to or greater than the threshold value, the second flow path is disconnected, so that the heat generated by the drive device is effectively accumulated in the heat medium flowing through the second flow path. Therefore, it is possible to equalize the temperature of the power storage device and effectively utilize the heat generated from the drive device.

### Aspect 2

The thermal management system according to aspect 1, further comprising a pump that is provided in the fourth flow path and that sends the heat medium toward the chiller, wherein the pump stops when the temperature difference becomes the threshold value or a value less than a set value smaller than the threshold value.

In this aspect, the pump stops when the temperature difference between the high-temperature part and the low-temperature part of the power storage device becomes relatively small, so the electric power required to drive the pump is reduced.

### Aspect 3

The thermal management system according to aspect 1 or 2, further comprising a grille shutter that is able to adjust a volume of air flowing toward the radiator by adjusting an opening degree, wherein when the temperature difference is equal to or greater than the threshold value, the switching device separates the second flow path from the other flow paths, and makes a circuit in which the heat medium circulates through the first flow path, the third flow path, and the fourth flow path, and the grille shutter is closed.

The embodiments disclosed herein should be considered as illustrative and not restrictive in all respects. The scope of the present disclosure is shown by the claims rather than the above embodiments, and also includes all modifications within the meaning and the scope equivalent to those of the claims.

What is claimed is:

1. A thermal management system provided in an electrical device, the thermal management system comprising:
a first flow path, a second flow path, a third flow path, and a fourth flow path through which a heat medium is able to flow;
a power storage device that exchanges heat with the heat medium flowing through the first flow path;
a drive device that exchanges heat with the heat medium flowing through the second flow path and supplies driving force to the electrical device;
a radiator provided in the third flow path;
a chiller provided in the fourth flow path; and
a switching device that is able to switch a connection state of the first flow path, the second flow path, the third flow path, and the fourth flow path, wherein when a temperature difference between a high temperature portion and a low temperature portion of the power storage device is equal to or greater than a threshold value, the switching device separates the second flow path from other flow paths, and makes a circuit in which the heat medium circulates through at least the first flow path and the fourth flow path.

2. The thermal management system according to claim 1, further comprising a pump that is provided in the fourth flow path and sends the heat medium toward the chiller, wherein the pump stops when the temperature difference becomes the threshold value or a value less than a set value smaller than the threshold value.

3. The thermal management system according to claim 1, further comprising a grille shutter that is able to adjust a volume of air flowing toward the radiator by adjusting an opening degree, wherein when the temperature difference is equal to or greater than the threshold value, the switching device separates the second flow path from the other flow paths, and makes a circuit in which the heat medium circulates through the first flow path, the third flow path, and the fourth flow path, and the grille shutter is closed.
